(19) United States
(12) Patent Application Publication
(10) Pub. No.: US 2005/0090275 A1
(43) Pub. Date: Apr. 28, 2005

(54) Active wireless data channel select mechanism

(75) Inventor: Mingheng Wang, Rochester Hills, MI (US)

Correspondence Address: General Motors Corporation;Legal Staff, Mail Code 482-C23-B21, 300 Renaissance Center, P.O. Box 300, Detroit, MI, 48265-3000, US

(73) Assignee: General Motors Corporation

(21) Appl. No.: 10/691,870

(22) Filed: Oct. 23, 2003

(51) Int. Cl. H04B 7/00

(52) U.S. Cl. 455/512; 455/513; 455/161.1

(57) ABSTRACT

The invention provides a method for providing a selected wireless connection between a telematics unit and a call center. The method provides a list of wireless networks with an associated ranking to the telematics unit and determines which wireless networks from the list of wireless networks are available for connection. The method also selects a first channel for a wireless network based on the determination and the associated ranking. The method also monitors the list for available networks and switches to a second channel based on a higher ranked available network.

### FIELD OF THE INVENTION

This invention relates generally to data transmission over digital cellular connections. In particular, this invention relates to a mechanism to actively select a wireless data channel.

### BACKGROUND OF THE INVENTION

Wireless data applications, such as Voice over IP (VoIP) calls are typically supported by a wired network with Personal Computers (PCs) and dedicated equipment. VoIP calls are transmitted over high-speed wireless data channels. Some of these channels include satellite radio networks, 3G wireless networks, and Wi-Fi networks. Various other high-speed networks continue to emerge. The rates of data transmission over the different networks may vary. The cost of transmission over the various networks may vary according to factors such as bandwidth and availability. Moreover, different networks may be available in different geographic areas and may fluctuate in signal strength throughout a coverage area.

Presently, a VoIP call is transmitted on a set communication data channel. If the transmission channel becomes unavailable during the call, the call is dropped and a new connection needs to be established to continue the data communication. The user's information may be lost and the process is both cost and time consuming. Moreover, the user has no control over what channels are used to transmit data.

Accordingly, it would be desirable to have a method to actively select a wireless data channel that overcomes the above disadvantages.

### SUMMARY OF THE INVENTION

One aspect of the present invention provides a method for providing a selected wireless connection between a telematics unit and a call center. The method provides a list of wireless networks with an associated ranking to the telematics unit and determines which wireless networks from the list of wireless networks are available for connection. The method also selects a first channel for a wireless network based on the determination and the associated ranking. The method also monitors the list for available networks and switches to a second channel based on a higher ranked available network.

Another aspect of the present invention provides a computer usable medium including a computer readable program for providing a selected wireless connection between a telematics unit and a call center. The computer usable medium comprises computer readable program code for providing a list of wireless networks with an associated ranking to the telematics unit and for determining which wireless networks from the list of wireless networks are available for connection. The computer usable medium also comprises computer readable program code for selecting a first channel for a wireless network based on the determination and the associated ranking. The computer usable medium further comprises computer readable program code for monitoring the list for available networks and for switching to a second channel based on a higher ranked available network.

Another aspect of the present invention provides a system for providing a selected wireless connection between a telematics unit and a call center. The system comprises means for providing a list of wireless networks with an associated ranking to the telematics unit and for determining which wireless networks from the list of wireless networks are available for connection. The system also provides means for selecting a first channel for a wireless network based on the determination and the associated ranking. The system also provides means for monitoring the list for available networks and for switching to a second channel based on a higher ranked available network.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a block diagram illustrating an operating environment in accordance with one embodiment, of the present invention;

FIG. 2 is a block diagram of a mobile vehicle interface for managing communication channels and transmitting data in accordance with one embodiment, of the present invention;

FIG. 3 is a flow diagram of a method to provide a selected wireless connection between a telematics unit and a call center in accordance with one embodiment, of the present invention; and

FIG. 4 is a flow diagram of a method to provide a selected wireless connection between a telematics unit and a call center in accordance with one embodiment, of the present invention.

### DETAILED DESCRIPTION OF THE DRAWINGS

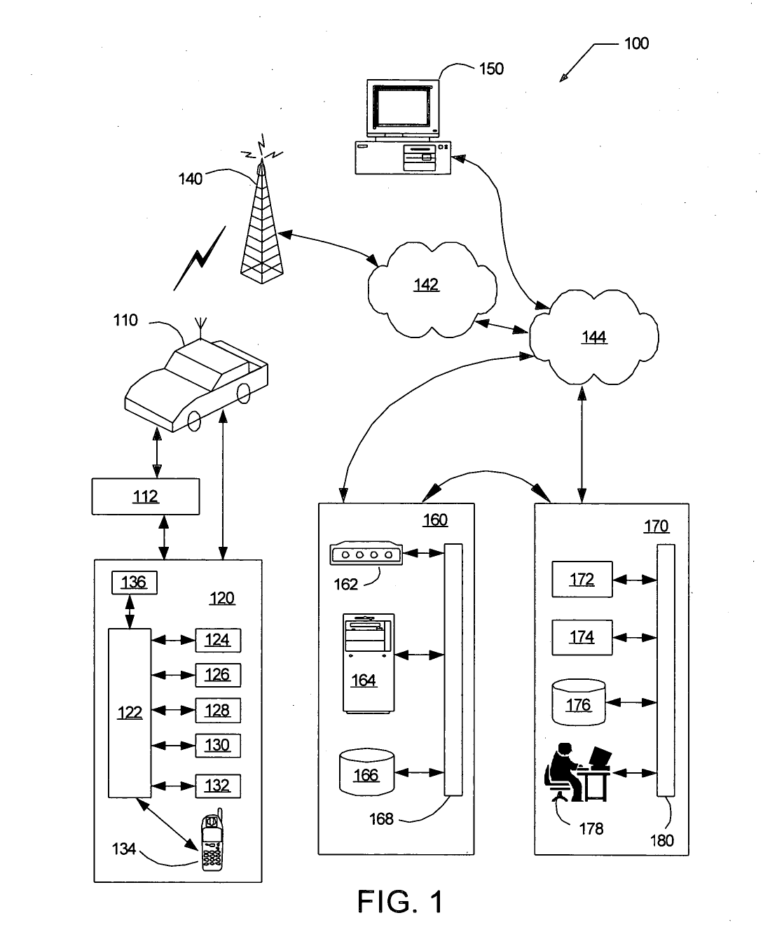

FIG. 1 is an illustrative operating environment for an embodiment, of the present invention. FIG. 1 shows a mobile vehicle communication system (MVCS) 100. Mobile vehicle communication system 100 includes mobile vehicle 110, vehicle communication bus 112, vehicle communications unit (VCU) 120, one or more wireless carrier systems 140, one or more communication networks 142, one or more land networks 144, one or more client, personal or user computers 150, one or more web-hosting portals 160, and one or more call centers 170. In one embodiment, mobile vehicle 110 is implemented as a mobile vehicle equipped with suitable hardware and software for transmitting and receiving voice and data communications.

In an embodiment, vehicle communications unit 120 is a telematics unit that includes a digital signal processor (DSP) 122 connected to a wireless modem 124, a global positioning system (GPS) unit 126, an in-vehicle memory 128, a microphone 130, one or more speakers 132, an embedded or in-vehicle mobile phone 134, and a vehicle communications platform (VCP) 136. DSP 122 is also referred to as a microcontroller, application specific integrated circuit (ASIC), microprocessor, controller, host processor, or vehicle communications processor. GPS unit 126 provides longitude and latitude coordinates of the vehicle, as well as a time stamp and a date stamp. In-vehicle mobile phone 134 is a cellular-type phone, such as, for example an analog, digital, dual-mode, dual-band, multi-mode or multi-band cellular phone. In another example, the mobile telephone system is an analog mobile telephone system operating over a predetermined band nominally at 800 MHz. The mobile telephone system is a digital mobile telephone system operating over a predetermined band nominally at 800 MHz, 900 MHz, 1900 MHz, or any suitable band capable of carrying mobile communications. Examples of such digital mobile telephone systems include code division multiple access (CDMA) (e.g. IS-95), Groupe Special Mobile (GSM), and time division multiple access (TDMA).

DSP 122 executes various computer programs that control programming and operational modes of electronic and mechanical systems within mobile vehicle 110. DSP 122 controls communications between telematics unit 120, wireless carrier system 140, and call center 170. In one embodiment, the DSP 122 manages communication channels and transmission of data through the VCP 136. In one embodiment, a voice-recognition application is installed in DSP 122 to translate human voice input through microphone 130 into digital signals. DSP 122 generates and accepts digital signals transmitted between telematics unit 120 and a vehicle communication bus 112 that is connected to various electronic modules in the vehicle 110. In one embodiment, the digital signals activate the programming mode and operation modes, as well as provide for data transfers. In this embodiment, signals from DSP 122 are translated into voice messages and sent out through speaker 132.

Mobile vehicle 110, via a vehicle communication bus 112, sends signals to various units of equipment and systems within mobile vehicle 110 to perform various functions such as unlocking a door, opening the trunk, setting personal comfort settings, and calling from telematics unit 120. In facilitating interactions among the various communication and electronic modules, vehicle communication bus 112 utilizes bus interfaces such as controller-area network (CAN), International Organization for Standardization (ISO) Standard 9141, ISO Standard 11898 for high-speed applications, ISO Standard 11519 for lower speed applications, and Society of Automotive Engineers (SAE) Standard J1850 for high speed and lower speed applications.

Mobile vehicle 110, via telematics unit 120, sends and receives radio transmissions from wireless carrier system 140. Mobile vehicle 110 may be in communication with one or more wireless carrier systems 140. Wireless carrier system 140 is implemented as any suitable system for transmitting a signal from mobile vehicle 110 to communication network 142. Wireless carrier system 140 incorporates any type of telecommunications in which electromagnetic waves carry signal over part of or the entire communication path. In one embodiment, wireless carrier system 140 transmits analog audio and/or video signals. In an example, wireless carrier system 140 transmits analog audio and/or video signals such as those sent from AM and FM radio stations and transmitters, or digital audio signals in the S band (approved for use in the U.S.) and L band (used in Europe and Canada). In one embodiment, wireless carrier system 140 is a satellite broadcast system broadcasting over a spectrum in the “S” band (2.3 GHz) that has been allocated by the U.S. Federal Communications Commission (FCC) for nationwide broadcasting of satellite-based Digital Audio Radio Service (DARS). In another example, wireless carrier system 140 includes a short message service, modeled after established protocols such as IS-637 SMS standards, IS-136 air interface standards for SMS, and GSM 03.40 and 09.02 standards. Similar to paging, an SMS communication could be broadcast to a number of regional recipients. In another example, the carrier uses services compliant with other standards, such as, for example, IEEE 802.11 compliant systems, Bluetooth systems, and the like.

Communication network 142 includes services from one or more mobile telephone switching offices and wireless networks. Communication network 142 connects wireless carrier system 140 to land network 144. Communication network 142 is implemented as any suitable system or collection of systems for connecting wireless carrier system 140 to mobile vehicle 110 and land network 144.

Land network 144 is a public-switched telephone network (PSTN). Mobile vehicle 110 may be in communication with one or more land networks 144. In one embodiment, land network 144 is implemented as an Internet protocol (IP) network. In other embodiments, land network 144 is implemented as a wired network, an optical network, a fiber network, another wireless network, or any combination thereof. Land network 144 is connected to one or more landline telephones. Land network 144 connects communication network 142 to user computer 150, web-hosting portal 160, and call center 170. Communication network 142 and land network 144 connects wireless carrier system 140 to web-hosting portal 160 and call center 170.

Client, personal or user computer 150 includes a computer usable medium to execute Internet browser and Internet-access computer programs for sending and receiving data over land network 144 and optionally, wired or wireless communication networks 142 to web-hosting portal 160. Personal or user computer 150 sends data to web-hosting portal through a web-page interface using communication standards such as hypertext transport protocol (HTTP), and transport-control protocol Internet protocol (TCP/IP). In one embodiment, the data includes vehicle data such as user preferences and selections and operational modes of electronic and mechanical systems within mobile vehicle 110. In operation, a driver utilizes user computer 150 to initiate setting or re-setting of user-preferences for mobile vehicle 110. Various vehicle data from client-side software is transmitted to server-side software of web-hosting portal 160. Other vehicle data is stored at web-hosting portal 160.

Web-hosting portal 160 includes one or more data modems 162, one or more web servers 164, one or more databases 166, and a network 168. Web-hosting portal 160 is connected, in one embodiment, directly by wire to call center 170, or connected by phone lines to land network 144, which is connected to call center 170. Web-hosting portal 160 is connected to land network 144 by one or more data modems 162. Land network 144 sends digital data to and from modem 162, and this data is subsequently transferred to web server 164. In one embodiment, modem 162 resides inside web server 164. Land network 144 transmits data communications between web-hosting portal 160 and call center 170.

Web server 164 receives data from user computer 150 via land network 144. In alternative embodiments, user computer 150 includes a wireless modem to send vehicle data to web-hosting portal 160 through a wireless communication network 142 and a land network 144. Data is received by modem 162 and sent to one or more web servers 164. In one embodiment, web server 164 is implemented as any suitable hardware and software capable of providing web services to transmit and receive vehicle data from user computer 150 to telematics unit 120 in mobile vehicle 110. Web server 164 sends to or receives data transmissions from one or more databases 166 via network 168. Web server 164 includes computer applications and files for managing vehicle data and generating targeted data.

In one embodiment, one or more web servers 164 are networked via network 168 to distribute vehicle data among its network components such as database 166. In an example, database 166 is a part of or a separate computer from web server 164. Web server 164 sends data transmissions to call center 170 via modem 162, and through land network 144.

Call center 170 is a location where many calls are received and serviced at the same time, or where many calls are sent at the same time. In one embodiment, the call center is a telematics call center, facilitating communications to and from telematics unit 120 in mobile vehicle 110. In an example, the call center is a voice call center, providing verbal communications between an advisor in the call center and a subscriber in a mobile vehicle. In another example, the call center contains each of these functions. In other embodiments, call center 170 and web-hosting portal 160 are located in the same or different facilities.

Call center 170 contains one or more voice and data switches 172, one or more communication services managers 174, one or more communication services databases 176, one or more communication services advisors 178, and one or more network 180.

Switch 172 of call center 170 connects to land network 144. Switch 172 transmits voice or data transmissions from call center 170, and receives voice or data transmissions from telematics unit 120 in mobile vehicle 110 through wireless carrier system 140, communication network 142, and land network 144. Switch 172 receives data transmissions from and sends data transmissions to one or more web-hosting portals 160. Switch 172 receives data transmissions from or sends data transmissions to one or more communication services managers 174 via one or more networks 180.

Communication services manager 174 is any suitable hardware and software capable of providing communication services to telematics unit 120 in mobile vehicle 110. Communication services manager 174 sends to or receives data transmissions from one or more communication services databases 176 via network 180. Communication services manager 174 sends to or receives data transmissions from one or more communication services advisors 178 network 180. Communication services database 176 sends to or receives data transmissions from communication services advisor 178 via network 180. Communication services advisor 178 receives from or sends to switch 172 voice or data transmissions.

Communication services manager 174 facilitates one or more services, such as, but not limited to, enrollment services, navigation assistance, directory assistance, roadside assistance, business or residential assistance, information services assistance, emergency assistance, and communications assistance and vehicle data management services. Communication services manager 174 receives service requests for services from a user via user computer 150, web-hosting portal 160, and land network 144. Communication services manager 174 transmits and receives vehicle data to telematics unit 120 in mobile vehicle 110 through wireless carrier system 140, communication network 142, land network 144, voice and data switch 172, and network 180. Communication services manager 174 stores or retrieves vehicle data and information from communication services database 176. Communication services manager 174 may provide requested information to communication services advisor 178.

In one embodiment, communication services advisor 178 is a real advisor. In another embodiment, communication services advisor 178 is implemented as a virtual advisor. In an example, a real advisor is a human being at service provider service center in verbal communication with service subscriber in mobile vehicle 110 via telematics unit 120. In another example, a virtual advisor is implemented as a synthesized voice interface responding to requests from telematics unit 120 in mobile vehicle 110.

Communication services advisor 178 provides services to telematics unit 120 in mobile vehicle 110. Services provided by communication services advisor 178 include enrollment services, navigation assistance, real-time traffic advisories, directory assistance, roadside assistance, business or residential assistance, information services assistance, emergency assistance, and communications assistance. Communication services advisor 178 communicates with telematics unit 120 in mobile vehicle 110 through wireless carrier system 140, communication network 142, and land network 144 using voice transmissions, or through communication services manager 174 and switch 172 using data transmissions. Switch 172 selects between voice transmissions and data transmissions.

Mobile vehicle 110 initiates service requests to call center 170 by sending a voice or digital-signal command to telematics unit 120 which in turn, sends an instructional signal or a voice call through wireless modem 124, wireless carrier system 140, communication network 142, and land network 144 to call center 170. In another embodiment, the service request is for a vehicle data upload. In yet another embodiment, the mobile vehicle 110 receives a request from call center 170 to send various vehicle data from mobile vehicle 110 through telematics unit 120, wireless modem 124, wireless carrier system 140, communication network 142, and land network 144 to call center 170.

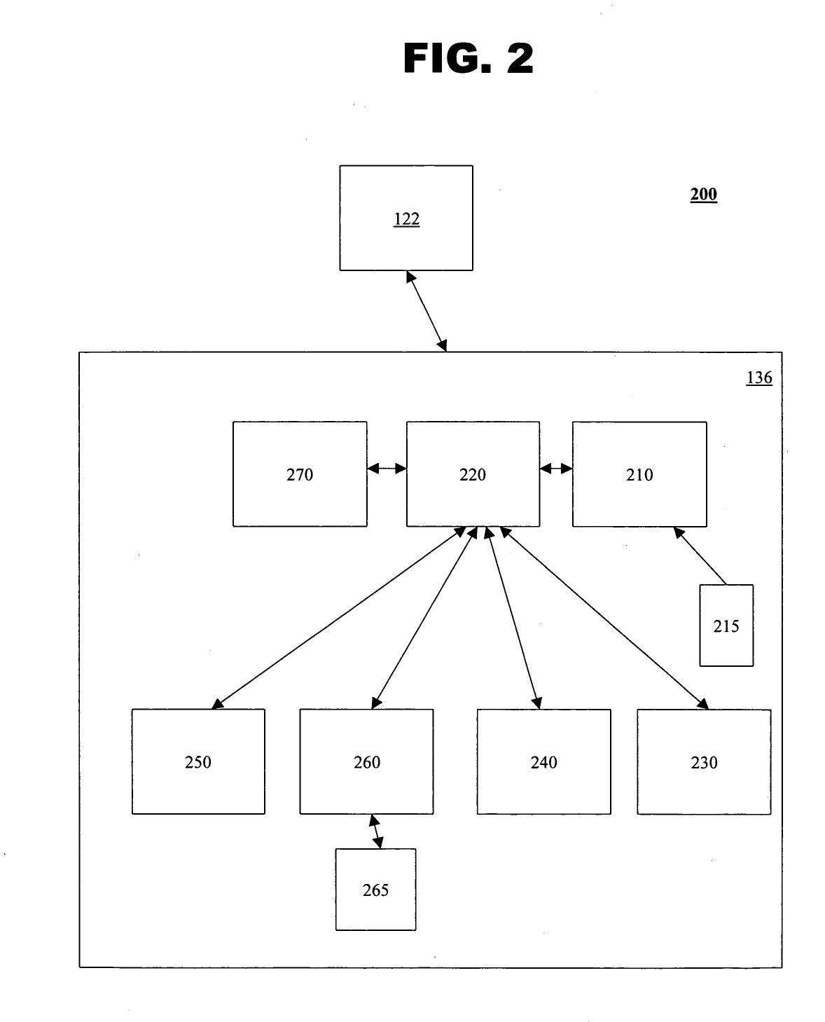

FIG. 2 is a block diagram of one embodiment, of a mobile vehicle interface for managing communication channels and transmitting data.

FIG. 2 shows a mobile vehicle interface for managing data transmission 200. In one embodiment, DSP 122 is connected to and manages data transmission through VCP 136. A user accesses VCP 136 remotely or directly while inside the vehicle 110. VCP 136 contains a number of modules for managing vehicle data transmission.

A flash memory module 210 is located, in one embodiment, on the VCP 136. In one embodiment, flash memory 210 is programmed to store necessary information to efficiently manage communications. Flash memory 210 receives relayed information from the wireless carrier system 140. Flash memory 210 is in communication with a preference table 215 that ranks available data transmission channels. Data transmission channels are located on the wireless carrier systems 140 and may include, but are not limited to, any carrier system 140 as described above in FIG. 1. In one embodiment, a user can determine his/her preferences for the data channels by accessing a website through user computer 150, a mobile device such as a laptop computer, a personal digital advisor (PDA), or a telematics unit interface inside of a mobile vehicle 110. In another embodiment, preference table 215 is continually updated from a remote node or call center 170.

In another embodiment, the flash memory module 210 is non-volatile memory, such as a disk. In such embodiments, the non-volatile memory functions identically as the flash memory described above.

Preference table 215 provides a ranking system for data transmission channels. In one embodiment, the preference table 215 is remotely accessed and programmed by a user. A user determines a ranking for available data channels based on personal preferences. In one embodiment, user preferences include cost of a data channel, availability of a data channel within a specific area, speed of data transmission on a data channel, reliability of a data channel, security of a data channel, and signal strength of a data channel in a specific area.

Each data channel has certain usability characteristics such as cost, availability, speed of transmission, reliability, security, and signal strength. The cost of each data channel varies based on area, amount of coverage, and various other factors. Availability of data channels within a specific area also varies based on service providers and area of coverage. Speed of data transmission varies based upon each channel's bandwidth and speed capability. The reliability of each data channel may also vary based upon geography and availability of signal reception. The security of each data channel may be dependent on various security protocols guiding each channel as is well known in the art. The signal strength of data channels in specific areas also varies due to distance from a wireless network, geographical conditions that impact reception and transmission, and geographical or architectural barriers such as mountains or tunnels. In one embodiment, the above factors are collected, evaluated, and presented to a user by a service provider, a call center, or a combination of both.

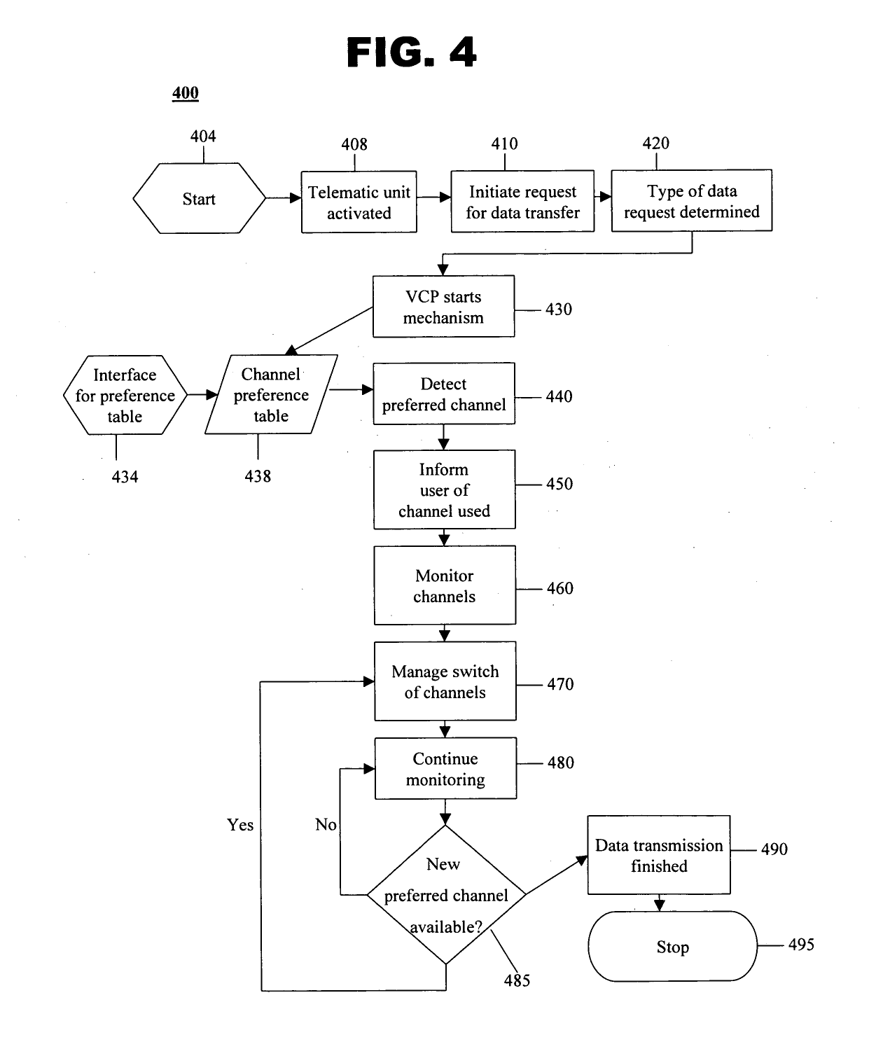

The flash memory 210 also stores a mechanism 220 to actively select wireless data channels. Mechanism 220 provides a selected wireless connection between a telematics unit and a call center. The mechanism 220 integrates user rankings of the data channels on preference table 215 and directs switching of data channels used for data transmission. The method of the wireless data channel selection mechanism 220 is described further in FIG. 4.

In one embodiment, the wireless data channel selection mechanism 220 is in communication with a satellite radio interface 230 as well as other interfaces. Satellite radio interface 230 receives a satellite signal from any number of satellite providers. In one embodiment, such satellite signals comprise GPS satellite and XM satellite radio signals. In one embodiment, satellite radio interface 230 determines availability of a satellite data channel, signal strength of a satellite signal, security of the satellite channel, and fluctuations of the signal over time. The satellite radio interface 230 passes information and receives commands from the wireless data channel selection mechanism 220.

In another embodiment, wireless channel selection mechanism 220 is in communication with a Wireless Fidelity (Wi-Fi) interface 240 as well as other interfaces. The Wi-Fi interface 240 is in communication with an 802.11 connection to a Wi-Fi access point (hotspot). In one embodiment, the carrier uses services compliant with standards such as IEEE 802.11 compliant systems, Bluetooth systems, and the like. The Wi-Fi hotspot may contain a Wi-Fi access device, firewalls, and other systems that facilitate access to a secure data connection. In one embodiment, the Wi-Fi interface 240 determines availability of a Wi-Fi channel, security of the channel, signal strength of the Wi-Fi channel, and fluctuations of the signal over time. The Wi-Fi interface 240 passes information and receives commands from the voice channel selection mechanism 220.

In yet another embodiment, wireless data channel selection mechanism 220 is in communication with a cellular interface 250 as well as other interfaces. Cellular interface 250 is in communication with a digital or analog wireless carrier network. In one embodiment, cellular interface 250 is in communication with a 3G wireless network. Cellular interface 250 determines availability of a cellular data channel, signal strength of a cellular signal, security of the cellular channel, and fluctuations of the signal over time. The cellular interface 250 passes information and receives commands from the wireless data channel selection mechanism 220.

In yet another embodiment, wireless data channel selection mechanism 220 is also in communication with a digital computing device interface 260 via the VCP 136. Digital computing device interface 260 is in communication with any number of digital computing devices 265. In one embodiment, a digital computing device 265 is in remote communication with the digital computer device interface 260 via a remote connection. In another embodiment, the digital computer devices are in direct communication with digital computer interface 260. The directly connected digital computer devices 265 can be plugged into the digital computer device interface 260 on the telematics unit 120. Digital computer devices 265 comprise any computing or adaptable digital device that can transmit or store data remotely to the telematics unit, such as a laptop computer or a PDA. The VCP 136 thus serves as an access point for digital computer devices 265.

Other modules 270 are in communication with wireless channel selection mechanism 220. In one embodiment, modules 270 include any number of software programs and interfaces available on the telematics unit.

In one embodiment, the mechanism 220 is programmed directly onto the vehicle telematics unit 120, or downloaded to it remotely. In another embodiment, the mechanism 220 is programmed directly or remotely onto a mobile device such as a laptop, PDA, or mobile telephone that is in communication with a number of wireless carriers 140.

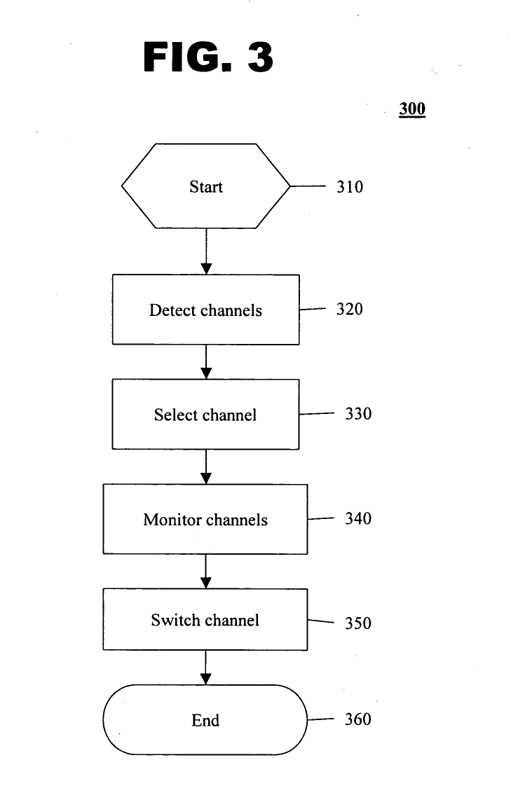

FIG. 3 is a flow diagram of one embodiment, of a method to provide a selected wireless connection between a telematics unit and a call center in accordance with one embodiment, of the present invention.

FIG. 3 describes an exemplary method 300 of actively selecting a wireless data channel. The method begins at block 310.

Method 300 scans for available data channels from a list of existing channels on wireless networks 140 at block 320. In one embodiment, a channel signal strength threshold determines availability of a data channel. If the data channel is at, or above, the designated signal strength, then the data channel is determined to be an available data channel. Available data transmission channels are then compared with a ranking of data channels. In one embodiment, a preference table 215 provides the ranking of data channels.

The most preferred channel is selected from the available data channels at block 330. Method 300 thus selects a first channel. In one embodiment, a connection is established between the telematics unit 120 and a remote node when a first channel is selected.

Existing networks are then monitored for available channels at block 340. In one embodiment, monitoring the channels involves scanning all existing data channels within a predetermined time period.

If a new channel becomes available that is ranked higher than the first selected channel, then the method 300 switches to the higher ranked channel at block 350. Method 300 thus selects a second channel. The wireless carrier network 140 being used is switched to the more preferred channel, and the data being transmitted is switched to the new network without losing or dropping the previously transmitted data. The telematics unit thus remains in communication with the remote node where data is being transferred. Similarly, if the channel being used for data transmission becomes unavailable then the method 300 switches the data transmission to the next highest ranked and available data channel.

In one embodiment, the method 300 is optimized for a data packet connection between a telematics unit and a call center. Data packet connection optimization allows uninterrupted transmission of data between the telematics unit and the call center. In another embodiment, the method is optimized generally for any connection over a digital wireless network. The term ‘digital’ may be understood to encompass all forms of communication that are not in analog format.

The method 300 stops at block 360.

FIG. 4 is a flow diagram of a method to provide a selected wireless connection between a telematics unit and a call center, in accordance with another embodiment, of the present invention.

FIG. 4 describes an exemplary method 400 of using the wireless data channel selection mechanism 220. The method 400 starts at block 404. The telematics unit 120 is activated at block 408 by a user in the mobile vehicle 110 or by a remote node. The telematics unit 120 then initiates a request for a data transfer at block 410. A type of data transfer is then determined at block 420. In one embodiment, the format and amount of data to be transferred is determined to optimize transmission.

The VCP 136 then accesses the flash memory 210 and initiates the wireless data channel selection mechanism 220 at block 430. In one embodiment, a channel preference table 215 is accessed at block 438 to determine a ranking for available data channels.

The preference table 215 may be accessed and modified remotely from a call center 170 or by a user at block 434. In one embodiment, the user changes their preferences through a user computer 150 by accessing an Internet website. In another embodiment, the user accesses and modifies the table 215 directly through an interface on the VCP 136.

The telematics unit 120 scans for available data channels from a list of existing channels on wireless networks 140 at block 440. In one embodiment, a channel signal strength threshold determines availability of a data channel. If the data channel is at or above the designated signal strength then it is determined to be an available data channel. Available data transmission channels are then compared with the channel preference table 215 and the preferred data channel is selected from the available data channels. In one embodiment, the method 400 first searches for availability of a Wi-Fi channel as Wi-Fi networks are often free and may therefore be ranked as the highest data channel.

Availability of data channels is further determined by any one of the factors described above in FIG. 2. These factors comprise cost of a data channel, availability of a data channel within a specific area, speed of data transmission on a data channel, reliability of a data channel, security of a data channel, and signal strength of a data channel in a specific area.

In one embodiment, data transmission begins at block 440 as soon as a preferred available data channel is detected. In another embodiment, the method 400 waits until the user is informed of the data channel being used at block 450 to begin data transmission.

In one embodiment, the user is informed of the channel being used for data transfer at block 450. In one embodiment, the channel in use for data transmission is indicated on a telematics unit display. In another embodiment, the user is informed of the data channel being used by a voice prompt played through the speakers of the telematics unit. If data transmission has not started at block 440 then data transmission begins at block 450, after the user has been informed of the channel being used for data transmission.

Existing networks are then monitored for available channels at block 460. Each data channel has certain usability characteristics such as cost, availability, speed of data transmission, reliability, security, and signal strength within an area. In one embodiment, monitoring the channels involves scanning all available data channels to determine their usability characteristics. In one embodiment, the method scans for available data channels every 100 ms, effectively scanning in real time. In a second embodiment, the method scans for available data channels every 1 to 3 seconds.

If a new channel becomes available that is ranked higher by a user than the channel being used for data transmission, then the mechanism 220 manages a switch to the higher ranked channel at block 470. The wireless carrier network 140 being used is switched to the more preferred channel, and the data being transmitted is switched to the new network without losing or dropping the previously transmitted data. The telematics unit thus remains in communication with the remote node where data is being transferred. Similarly, if the channel being used for data transmission becomes unavailable then the mechanism 220 switches the data transmission to the next highest ranked and available data channel.

In one embodiment, a default data channel is designated. The default data channel is used to transmit data if no other higher ranked channels are available, or if a ranking for data channels is not available. In one embodiment, a default data channel comprises a digital mobile telephone channel. In another embodiment, a default data channel comprises a satellite data channel.

After switching channels at block 470, existing data channels continue to be monitored for available data channels at block 480. The method 400 continues to check for an available channel that is higher ranked to become available or for a channel being used for data transmission to become unavailable at block 485. If a new channel does become available, or a channel being used for transmission becomes unavailable then the mechanism 220 again manages the switch of the data channel used for data transmission at block 470. In one embodiment, the user is informed every time the transmission data channel is switched to a new channel. Following the switch at block 470 the existing data channels continue to be monitored at block 480 for availability.

Data transmission finishes at block 490. The transmission may be ended by a user, a remote node, or automatically by means of all of the data being transmitted. The telematics unit 120 then disconnects from the wireless network 140 and signals to the mechanism 220 that data transmission has been ended. The mechanism 220 is then turned off.

In one embodiment, the method 400 is optimized for a data packet connection between a telematics unit and a call center. Data packet connection optimization allows uninterrupted transmission of data between the telematics unit and the call center. In another embodiment, the method is optimized generally for any connection over a digital wireless network. The term ‘digital’ may be understood to encompass all forms of communication that are not in analog format.

The method 400 stops at block 495.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method of providing a selected wireless connection between a telematics unit and a call center comprising;
providing a list of wireless networks with an associated ranking to the telematics unit;
determining which wireless networks from the list of wireless networks are available for connection;
selecting a first channel for a wireless network based on the determination and the associated ranking;
monitoring the list for available networks; and
switching to a second channel based on a higher ranked available network.

2. The method of claim 1 wherein the associated ranking is determined by a preference table.

3. The method of claim 1 wherein the associated ranking can be determined by a user.

4. The method of claim 1 wherein availability is determined by a signal threshold.

5. The method of claim 1 wherein monitoring of available data channels further comprises:
scanning for available data channels within a predetermined time period.

6. The method of claim 5 wherein scanning within a predetermined time period comprises scanning in substantially real time.

7. The method of claim 1 further comprising:
switching to a channel while data transmission is in progress on a different channel.

8. The method of claim 1 wherein the telematics unit is in communication with a mobile device.

9. The method of claim 1 wherein the telematics unit further comprises:
a mobile communication device.

10. A computer usable medium including a program for providing a selected wireless connection between a telematics unit and a call center comprising:
computer readable program code for providing a list of wireless networks with an associated ranking to the telematics unit;
computer readable program code for determining which wireless networks from the list of wireless networks are available for connection;
computer readable program code for selecting a first channel for a wireless network based on the determination and the associated ranking;
computer readable program code for monitoring the list for available networks; and
computer readable program code for switching to a second channel based on a higher ranked available network.

11. The computer usable medium of claim 10 wherein the associated ranking is determined by a preference table.

12. The computer usable medium of claim 10 wherein the associated ranking is determined by a user.

13. The computer usable medium of claim 10 wherein availability is determined by a signal threshold.

14. The computer usable medium of claim 10 wherein monitoring of available data channels further comprises:
scanning for available data channels within a predetermined time period.

15. The computer usable medium of claim 14 wherein scanning within a predetermined time period comprises scanning in real time.

16. The computer usable medium of claim 10 further comprising:
switching to a channel while data transmission is in progress on a different channel.

17. The computer usable medium of claim 10 wherein the telematics unit is in communication with a mobile device.

18. The computer usable medium of claim 10 wherein the telematics unit further comprises:
a mobile communication device

19. A system for providing a selected wireless connection between a telematics unit and a call center comprising:
means for providing a list of wireless networks with an associated ranking to the telematics unit;
means for determining which wireless networks from the list of wireless networks are available for connection;
means for selecting a first channel for a wireless network based on the determination and the associated ranking;
means for monitoring the list for available networks; and
means for switching to a second channel on a higher ranked available network.

20. The system of claim 19 further comprising means for the telematics unit to be in communication with a mobile device.
